(19) United States
(12) Patent Application Publication
(10) Pub. No.: US 2014/0014748 A1
(43) Pub. Date: Jan. 16, 2014

(54) SYSTEM FOR SHREDDING AND GRINDING BIOMASS

(71) Applicant: James Russell Zeeck, Gretna, NE (US)

(72) Inventor: James Russell Zeeck, Gretna, NE (US)

(21) Appl. No.: 14/029,197

(22) Filed: Sep. 17, 2013

Related U.S. Application Data
(63) Continuation-in-part of application No. 13/341,319, filed on Dec. 30, 2011, now Pat. No. 8,551,549.
Application No. 13/341,319 is a continuation-in-part of application No. 13/213,629, filed on Aug. 19, 2011.
Application No. 13/213,629 is a continuation-in-part of application No. 12/538,351, filed on Aug. 10, 2009.
(60) Provisional application No. 61/176,541, filed on May 8, 2009.

(51) Int. Cl. B02C 23/38; B02C 23/02

(52) U.S. Cl. CPC B02C 23/38; B02C 23/02
USPC 241/18; 241/29; 241/24.25; 241/24.1; 241/152.2; 241/43; 241/78; 241/42; 241/68

(57) ABSTRACT

A method and system for processing biomass material from harvest to pelletizing includes a continuous shredding stage and grinding stage to reduce the size of the material. A fan pulls air through the shredder and the grinder to assist the movement of the biomass material through the shredder and the grinder. Due to the light weight of the biomass material, the material is transported between the shredding and grinding stages mechanically and pneumatically by a combination auger with air assist. The biomass material may include agricultural residues, such as corn stover. The process and equipment eliminates or minimizes damage to the carbohydrates in the biomass so as to maintain pre-grinding cellulose and hemi-cellulose levels.

### CROSS-REFERENCE TO RELATED APPLICATIONS

This application is a Continuation-in-part of U.S. Ser. No. 13/341,319 filed Dec. 30, 2011, which is a Continuation-in-part of U.S. Ser. No. 13/213,629 filed Aug. 19, 2011, which is a Continuation-in-part of Ser. No. 12/538,351 filed Aug. 10, 2009 which claims priority under 35 U.S.C. §119 to provisional application Ser. No. 61/176,541 filed May 8, 2009, all of which are hereby incorporated by reference in their entirety.

### FIELD OF THE INVENTION

The present invention allows for the expansion of biomass processing through a two-stage process for the shredding and secondary grinding of biomass feedstock with the use of air flows and pneumatic assist components that provide increased throughput capacity for higher moisture and fibrous feedstock while maintaining a narrower particle specification variance, reducing commercial production horse power requirements, and meeting air quality standards established by the EPA and permit requirements from local agencies that govern the processing of agricultural residues and energy crops, that current designed systems are unable to do.

### BACKGROUND OF THE INVENTION

Biomass feedstock is used in numerous industries such as feed industry and on a pilot scale in the production of cellulosic ethanol, electricity, heating fuels, and other commercial applications. With increasing biomass demand from the growth in liquid biofuels production, expanding demand for electricity generation, and accelerating expansion of engineered feed production and bio-chemical processing, a reliable and economic commercial scale design for the shredding and grinding of the biomass feedstock is needed. One of the main challenges to commercial scale production is the inability of biomass feed stocks like corn stover, wheat straw, and other energy crops to flow freely during processing without intermittent jamming. There is a need for a reliable and economic commercial scale design 7 days a week 24 hours a day for the shredding and grinding of the biomass feedstock that can meet New Source Performance Standards of the Clean Air Act.

Biomass shredding and grinding is predominantly done now with a tub grinder system that operates on a “batch” rather than continuous basis. In addition to being inefficient, tub grinding does not provide users with sufficient control of output specifications such as particle size, dust and related pollution levels, and is not able to grind agricultural residues with high moisture content on a continues basis.

Current state of art commercial practices use tub grinders which force biomass product through a screen using hammers and requiring excessive horse power. This is typically done with a mobile tub grinder unit in the agricultural sector and a mobile horizontal unit in the forest sector. The forestry industry is not required to meet New Source Performance Standards for mobile units govern by EPA on air quality standards for particulate, or narrow commercial particle specifications and combustion parameters, or demonstrate the ability to run 24 hours a day 350 days a year as required in economically viable commercial operations for engineered feed, cellulosic ethanol, and bio-plastic production.

The conventional tub grinders use hammers which repeatedly pulverize the biomass material until the material is sufficiently reduced in size to be forced through a screen by the hammers. This process overgrinds the material and produces a high percentage of fines. The conventional tub grinding process also produces excessive wear on the equipment. Furthermore, the hammers have a smaller footprint than the grinder screen, such that the full surface of the screen is not utilized. Typical tub grinders only utilize approximately 70% of the screen surface area effectively.

Shredding of the biomass fiber material inherently damages the cell walls due to heat caused by friction and shearing, and thus partially breaks down the hemicellulose and cellulose fiber of the material. The repeated pulverization in the tub grinder further damages the cell wall and further destroys the hemicellulose and cellulose fibers, thereby reducing the nutritional value of feed produced from the biomass material.

The 2005 “Billion-Ton Study” by the U.S. Department of Energy and U.S. Department of Agriculture concluded that agricultural and forest based biomass can displace 30% of U.S. petroleum consumption by using approximately the one billion dry tons of biomass feedstock produced each year by the US agricultural and timber industries.

The Energy Independence and Security Act of 2007 requires the United States to make one billion gallons of cellulosic ethanol from wheat straw, corn stover, rice straw, soybean stubble, milo stubble, forage sorghum, prairie hay, woodchips, cotton-gin residue, and a dozen other forms of agricultural waste which will require the need for economic commercial scale processes. In the past, such waste and agricultural residue materials have had little or no value. Meaningful volumes of cellulosic biomass and agriculture residue materials have not been brought to market on a reliable commercial scale due to the difficulties in integrating the supply chain to source, harvest, transport, store, and process the materials on a consistent and profitable basis.

To have a profitable supply chain, a commercial system must be invented that provides 24-hour per day operation with constant and reliable biomass particle production that meets air quality and permit standards. At the present time, cellulosic biomass is the only sustainable transportation oriented liquid fuel. Thus, when correctly pursued, cellulosic ethanol can address many of the issues undermining national security and environmental well-being. As a result of the US government push towards cellulosic fuel, other biomass industry segments such as engineered feed, biochemical production, and electricity production will also benefit from the design of a profitable biomass supply chain system while helping to meet national security and environmental goals.

Biomass production from corn, soy, and wheat stover has not been practical or economical due to several barriers and risks. The use of stover in commercial scale production has been unsuccessful primarily due to (1) cost and transportation logistics (due to very low density); (2) cost of storage including degradation from weather and fire prevention; (3) stover pellet durability to withstand handling and transportation; (4) inability to use current handling/storage infrastructure, resulting in high capital and operating costs; and (5) lack of proven and reliable pellet production technology that increases biomass density and works on a mass scale.

Furthermore, traditional mobile biomass shredding and processing units often used for stover and similar agriculture residues do not work for standard material handling or pelletizing units due to the stringy fibers and low specific gravities of these residues which tend to plug and block these mobile and other standard handling and processing systems.

### SUMMARY OF THE INVENTION

A primary objective of the present invention is the provision of an innovative systems-based approach to efficiently and economically shred and grind agricultural residues and other biomass prior to it being processed. With the present invention, residues or other biomass particle size after shredding and grinding will be more uniform than particles coming from traditional tub grinding. The particles will maintain their pre-grinding cellulose and hemi-cellulose levels with minimal damage because degradation or damage of complex carbohydrates in the biomass will be substantially limited as compared to current shredding and grinding practices. Unlike the traditional single stage tub and horizontal grinding batch process, the two stage continuous shredding and grinding system of the present invention allows for rapid, economic, and sustainable development of energy crops and agricultural residues as a feed stock, such as corn stover and wheat straw, so that the biomass industry can utilize existing grain industry transportation and storage infrastructure after the agricultural residue or other biomass is processed or pelletized.

### DESCRIPTION OF THE DRAWINGS

FIG. 1 is schematic flow diagrams for a preferred arrangement of the shredding and grinding system according to the present invention.

### DESCRIPTION OF THE INVENTION

The raw material is received as truckloads of baled agricultural residue or other biomass and converted into a final pelletized product that can be handled and transported using standard grain handling equipment. Because the handling and transportation costs for the pelletized product is reduced, two or more of these stover collection and processing facilities can be linked into a delivery system for end users needing commercial volumes of pelletized biomass feedstock. These facilities will process the material at the site, thus providing a further transportation competitive advantage, while limiting commercial risk.

The major processing equipment is connected using the established material handling systems. The layout is designed to provide an efficient and continuous process with ample room for efficient maintenance.

The invention allows material sizes ranging from raw material bales as inputs to finished pellets as the final output product. The design incorporates the best available material handling equipment for the product handled at a given stage.

The material flow process is substantially automated and is controlled by the process control system. A PC based HMI (Human Machine Interface) allows an operator to monitor and adjust processing conditions for this entire process after the raw material is delivered to the first conveyor of the system.

Material handling equipment for this process is designed specifically for each of the processing steps. The material handling design is complicated by the wide range of product sizes and densities. Following is a list highlighting the biomass specifications at key handling and processing stages:
1. Bales of harvested biomass measuring 3′×4′×8′ and weighing 1,000 to 1,400 pounds each, as well as round bales.
2. Shredded material from first stage biomass shredding, preferably to 1-3″ pieces, with air assist weighing 1.5 to 5 pounds per cubic foot.
3. Ground material from second stage biomass grinding, with fines preferably 6 to 9 pounds per cubic foot.
4. Finished Pellets, 38 to 42 pounds per cubic foot.
   The conveying systems consist of both mechanical conveyors and pneumatic systems as the use dictates. All have been designed to make the most efficient use of equipment, taking into consideration of the type of materials to be conveyed and the planned airflows for grinder assist and dust collection requirements of the various process stages.

The bale handling equipment is designed for removing 12 bales at a time from a stack and delivering them to the shredder feed conveyors where they are offloaded directly onto a destacking table. From destacking table the bales are delivered two at a time to an indexer feed conveyor. The indexer delivers the bales one at a time to the bale feed conveyor. The bale feed conveyor continuously delivers the bales end to end into the shredder feeding system where powered rollers convey the bale into the shredding chamber where the shredder rotor tears them apart and breaks-up the baled biomass as it is ground through the shredder screen. The shredded material is conveyed by an air assist with approximately 4000-8000 CFM of air through the screen of the shredder. This allows for even and uniform grinding through the shredder screen with a reduced horse power requirement (compared to tub grinding the same material amount) and an increased production throughput level of approximately 10%-30% depending on the moisture level of the incoming material. This system is a totally automated process using a combination of drag chains on feeder tables and hydraulic placers to deliver the bales to the tables and conveyors in the proper orientation for processing.

From the shredder the shredded material is conveyed on a 48″ sealed drag conveyor specially designed to create a sealed discharged chamber after the screen section of the shredder. This system is custom designed depending on the shredder used. The product then continues to the pneumatic classifier located over the secondary grind system, which typically is a hammermill. The width of this conveyor is dictated by the bulk volume of the shredded stover and to provide a material spread across the 56″ wide Pneumatic Classifier. A powerful magnet located over the conveyor is used to remove “tramp” metal from the shredded biomass stream.

The pneumatic classifier is designed to remove other foreign material from the shredded biomass stream ahead of the hammermill. In the next stage, the shredded biomass which is now free of metal and non-biomass material gravity flows from the classifier into the air swept hammermill. Approximately another 2000-4000CFM of air is pulled into the grinding chamber from the classifier with the air from the shredder also providing some air assist to pull the shredded biomass into the grinding chamber.

Ground biomass discharges from the bottom of the hammermill into an air plenum where it is air conveyed into a high efficiency separation cyclone which discharges into a collection conveyor through a seal conveyor. A fan on the discharge of each cyclone provides pressure for the airflow through the process. Each fan discharges into a combined bag filter for emission control. This allows classifying the shredder for air quality standards.

The ground biomass collection conveyor receives the ground biomass from each sizing line before proceeding under the surge bin to fill the conveyor. A variable speed drive on this metering conveyor sets the flow to the balance of the process and prevents overloading the conveyor.

The balance of the material handling equipment is made up of standard conveying equipment except the Pellet Mill Feed Conveyor. This is a drag conveyor with a center plate that allows ground biomass to be transferred and conveyed to the pellet mill feed conveyors and finally to the surge tank. Because the shredded and ground biomass is prone to blockage in spouts, short open transitions with no or reverse slop spouts are used.

Airflows are a unique and critical component in the design of the invention. Airflows are used in the invention process and have never been done on shredder for the following:
1. Dust Abatement
2. Air assist on the shredders and hammer mills
3. Distribution across the screen and pulled through rather than forced through as in traditional shredders
4. Reduce horse power requirements and increase design throughput by over 20%
5. Pneumatic Conveying
6. Material cooling and drying
7. Dust fines collection

A unique aspect of this invention is the sequence pneumatic conveying air usage for the following:
1. Dust abatement and air assist at the shredder chamber
2. Air assist at the pneumatic classifier
3. Classifying air at the pneumatic classifier
4. Air assist at the hammermill
5. Pneumatic conveying of the ground biomass
6. Distribution across the screen and pulled through rather than forced through as in traditional shredders
7. Reduce horse power requirements and increase design throughput by over 20%

The grinding process is designed to be an integrated, computer controlled, continuous process. Variable speed drives on the feeders for the grinding and air assist conveying equipment between the two stage systems are controlled by the amperage draw on the main motors shredder and motor to the secondary hammer mill will be the primary interlock to the system. This eliminates power overloads, surges, and material plugging that is common with low specific gravity material like agricultural residue and allows the equipment to operate at optimal capacity. A surge tank installed between the grinding and operations limits short-term variations of each operation and keeps the entire process operating at full capacity.

### Process Overview

For purposes of the following description, the process will be described using corn stover, though it is understood that other crop waste (such as soybean, wheat, barley, or sorghum stover) and energy crops (such as switch grass) can be used in the process along with other biomass feedstocks.

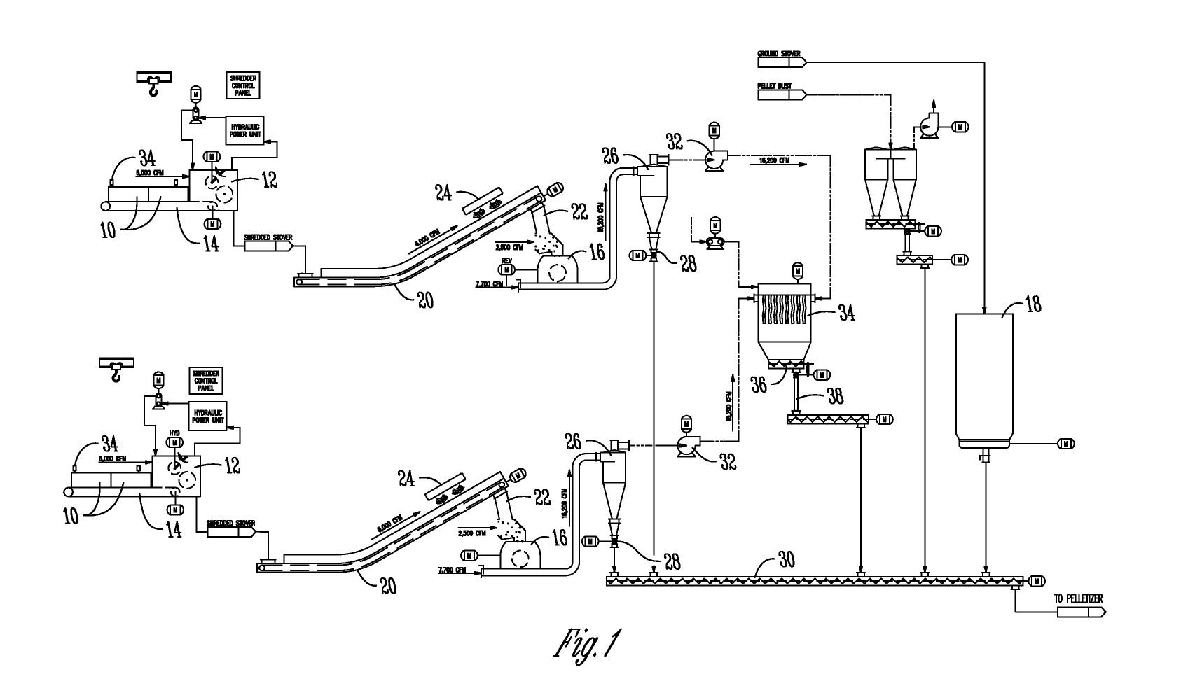

The following description applies generally to the process shown in FIGS. 1 and 2, which is one example of the present invention. The process can be scaled up or down as desired and modified depending on the feedstock without departing from the scope of the invention.

The process begins by harvesting and baling the biomass material. The bales are fed by conveyors into a shredder and then a grinder. The ground biomass material is then pelletized for storage and/or transport.

### Harvesting and Bale Handling

The equipment and processes for harvesting the biomass material, for baling the material, and for off-loading, destacking, indexing, accumulating and metering the bales of biomass material is described in parent application Ser. No. 12/538,351 and Ser. No. 13/341,319.

### Shredding

The biomass bales 10 are fed in a continuous stream with no gaps into a shredder 12 by a conveyor 14.

The in-feed conveyor 14 to the bale shredder 12 pushes the bales 10 into the bale shredder 14 in-feed roll. The in-feed conveyor 14 speed is varied along with the in-feed roll to provide constant load on the shredder 12 as determined by shredder amperage. The bale shredder 12 runs continuously at 90-95% max amps and is controlled by the bale shredder in-feed roller speed and the shredder in-feed conveyor 14 speed. The shredder 12 load set point is reset by the downstream grinder 16 full load amps, and/or the level in surge bin 18. The shredder in-feed conveyor 14 is hydraulic driven and controlled from the shredder 12 control panel. If the downstream grinder 16 starts to overload the shredder in-feed conveyor 14 speed is reduced. If the level in the surge bin 18 reaches its high limit, then the shredder in-feed conveyor 14 speed is reduced to prevent overfilling.

The flow of a stover bale 16 through the shredding and grinding operations is controlled by the hydraulic drive on the feed system that controls the flow of bales into bale shredders 10. The flow through the bale shredders 12 also controls the flow through the grinder 16 and ultimately controls the level in the bin 18. Surge bin 18 level is used to control the flow of bales to the process and ultimately maintain the surge bin 18 at the desired set point. High amp readings on the shredder 12 and/or corresponding grinder 16 motors will slow down or stop the material flow to prevent motor overloads.

The bale feed rate to the shredders 12 will be controlled by a three level control sequence. At the first level the load on the shredder motor will control the bale flow to maintain the shredder motor amperage at the desired set point. At the second level, the amperage on the grinder motor will override this control to prevent grinder overload. Finally the third level set point on the surge bin 18 will override the prior two controls to maintain the surge bin 18 at the desired operating level.

The shredded stover drops out of the bottom of the shredding chamber into the corn stover transfer conveyors 20. These drag conveyors 20 are specifically designed to collect and convey the shredded material from the shredder 12 to the pneumatic classifiers 22 located above the grinders 16. Magnets 24 suspended over the drag conveyors 20 are designed to remove ferric tramp metal from the shredded stover stream moving along the conveyor.

Approximately 6,000-8,000 CFM of air is pulled from each shredder chamber for dust control and grinding assist. This air stream is drawn from the shredder sealed chamber to the inlet of the pneumatic classifier 22 through a 48-inch half round cover on the transfer conveyor 20. This provides a means to move the air, along with any entrained material such as rocks and metal to the subsequent pneumatic classifier 22 and grinder 16 operations where approximately 2,000-4,000 CFM of make up air is introduced.

The pneumatic classifier 22 is designed to remove rocks and other heavier materials from the lighter shredded stover stream. The pneumatic classifiers 22 are also equipped with magnets to remove any remaining ferric tramp metal from the shredded stover prior to entering the hammer mills. The shredded stover gravity flows from the separator chamber, with some air assist, into the grinding chamber of the grinder 16.

### Grinding

The shredded material is ground in the grinder 16 to reduce the particle size. One example of a suitable grinder is a 400 HP, air swept hammer mill equipped with ¼ inch screens and hardened hammers. Each hammer mill 16 will require approximately 8,500-10,000 CFM of air to aid in the feeding of the light shredded material into the grinding chamber and assist in moving the ground material through the hammer mill screen. Under normal operation and low moisture material, the airflow into the hammer mill 16 is made up of 6,000 CFM of airflow from the bale shredder and another 2,500 CFM of air introduced into the pneumatic classifier 22.

The hammer mill 16 grinds the stover into a granular material with a particle size distribution that is essential for producing dense and durable pellets. The resulting granular material has a bulk density of approximately 6 pounds per cubic foot.

Each grinder 16 is equipped with a bottom disengagement chamber designed for air conveying of the ground from the hammer mill 16. The conveying air is comprised of the 8,500 CFM of airflow coming through the shredder 12 and classifier 22 along with another 7,400 CFM of airflow added as makeup air into the grinder disengagement chamber. These airflows can be adjusted at the shredder 12 and grinder 16 to optimize both the grinding operations and the subsequent air conveying systems.

Each air conveying system uses 15,900 CFM of air to pick up the ground material discharging through the grinder screens and convey it into cyclone separators 26. The separated ground material discharges the bottom of the cyclone separators 26 through ground stover collection cyclone airlocks 28 into the ground stover collection conveyor 30.

Ground stover transfer fans 32 provide the 15,900 CFM each of motive air for each conveying system. The air stream from each fan 32 is discharged into the baghouse 34 that collects any dust carried over from the cyclone separators 30. The baghouse 34 discharges the collected dust out the bottom of the baghouse hopper through baghouse discharge screw conveyor 36 and baghouse plug auger 38 and ultimately into the ground stover collection conveyor 30.

Ground stover collection conveyor 30 discharges to a ground stover bucket elevator and then to the pellet mill supply conveyor. Ground stover flow from the grinder 16 is augmented by a flow of material from the surge bin 18. This is fed into the ground stover collection conveyor 30 to maintain the capacity of the collection conveyor 30 at 100% full.

The shredding and grinding stages operate continuously for maximum output. As an example, with the present invention, a grinder with a 400 HP motor will produce 20 tons of material output per hour. In comparison, a conventional tub grinder with a 400 HP motor can produce 15 tons of material output per hour. Thus, the present invention is 33% more productive than conventional tub grinders while maintaining cellulose and hemi-cellulose levels of the biomass material, thereby preserving the nutritional value of the material for use as feed.

### Air Assist

The process of the present invention improves upon the prior art by providing air assist through the shredder 12 and grinder 16 so as to pull the biomass material through the shredder 12 and the grinder 16 to produce increased output volume and more consistent particle size. The air source fan 32 is located downstream from the shredder 12 and the grinder 16 so as to effectively provide a negative air flow through the system. Thus, air is pulled through the shredder 12, through the conveyor 20, and through the grinder 16 and thereby facilitates and increases passage of the biomass material through these components. The air flow through the grinder also increases the passage of uniform or consistently sized particles through the full surface area of the screen without excessive pulverizing and without creating substantial fines, as in the prior art. Thus, damage to the hemicellulose and cellulose fibers in the cell walls of the biomass material is minimized, thereby producing higher yields for liquid fuel use and increased digestibility for feed. Also, the air assist eliminates the need for a plenum at the grinder discharge, as is normally found in conventional prior art grinder configurations.

### Pelleting, Cooling, Storage, Load-Out, and Controls

The equipment and processes for pelletizing the ground material, cooling and storing the pellets, load-out of the pellets, and controls for the overall system are described in parent application Ser. Nos. 12/538,351 and 13/341,319.

### Conveying and Air Handling Calculations

The following tables provide one example of the biomass shredding and grinding system and process according to the present inventions. The specific numerical values in the tables may change upwardly or downwardly, depending on the capacity of the systems, without departing from the scope of the invention.

DC-1203A/B Shredded Stover Drag Conveyor

| | | |
|---|---|---|
| Conveyor Design Basis | 110% | of Planned Capacity |
| Design Material Flow | 35,200 | Lbs. per Flour |
| Material Bulk Density | 1.50 | Lbs. per Cu Ft |
| Material Flow Rate | 23,467 | Cu Ft per Hour |
| Trough Width | 48 | Inches Wide |
| Chain Speed | 100 | Feet per Minute |
| Material Conveying Depth | 11.73 | Inches |

Ground Stover Pneumatic Transfer Systems

| | | |
|---|---|---|
| Number of Systems | 2.0 | per Plant |
| Conveyor Design Basis | 110% | of Equipment Design Basis |
| Design Material Flow | 35,200 | Lbs. per Hour Each |
| Planned Conveying Air | 16,200 | ACFM Each |
| Product to Air Ratio | 0.036 | Lbs. Ground Stover per ACFM |

SC-1201 Ground Stover Transfer Screw Conveyor

| | | |
|---|---|---|
| Conveyor Design Basis | 110% | of Equipment Design Basis |
| Design Material Flow | 70,400 | Lbs. per Hour |
| Material Bulk Density | 6.00 | Lbs. per Cu Ft |
| Screw Conveyor Diameter | 24.00 | Inches |
| Screw Conveyor Pipe Diameter | 4.00 | Inches |
| Pitch | 24.00 | Inches |
| Cu Ft per Rev | 6.11 | Cu Ft |
| Conveyor Loading | 90% | Loading |
| Calculated Conveyor Speed | 35.57 | RPM (VF Drive, 50 RPM |
| | | Max Rate) |

K-1201 Ground Stover Surge Tank Size Calculations

| | | |
|---|---|---|
| Diameter | 16.00 | Feet |
| Sidewall Height | 16.00 | Feet |
| Bottom Cone Angle | 60.00 | Deg. |
| Volume | 4,146 | Cu Feet |
| Bulk Density | 7.20 | Lbs. per Cu Ft |
| Surge Capacity | 29,849 | Lbs. |
| | 33.34 | Minutes of Retention |

EL-1301 Ground Stover Bucket Elevator

| | | |
|---|---|---|
| Conveyor Design Basis | 110% | of Equipment Design Basis |
| Design Material Flow | 70,400 | Lbs. per Hour |
| Material Bulk Density | 6.00 | Lbs. per Cu Ft |
| Material Flow Rate | 11,733 | Cu Ft per Hour |
| Bucket Elevator Model | Model 3638 | Intersystem |
| Bucket Elevator Cup Size | 16 × 8(2) | Cup Size |

DC-1301 Pellet Mill Supply Drag Conveyor

| | | |
|---|---|---|
| Conveyor Design Basis | 110% | of Equipment Design Basis |
| Design Material Flow | 70,400 | Lbs. per Hour |
| Material Bulk Density | 6.00 | Lbs. per Cu Ft |
| Material Flow Rate | 11,733 | Cu Ft per Hour |
| Drag Conveyor Model | 30 × 17 | Series 17 Intersystem |
| Trough Width | 30 | inches |
| Chain Speed | 95 | Ft per Min |
| Material Conveying Depth | 9.88 | Inches |

| | |
|---|---|
| Special Design | Center Plate Full Length |

DC-1302 Pellet Mill Collection Conveyor

| | | |
|---|---|---|
| Conveyor Design Basis | 110% | of Planned Capacity |
| Design Material Flow | 59,092 | Lbs. per Hour |
| Material Bulk Density | 40 | Lbs. per Cu Ft |
| Material Flow Rate | 1,477 | Cu Ft per Hour |
| Drag Conveyor Model | 9 × 12 | Series 12 Intersystem |
| Trough Width | 9 | Inches |
| Chain Speed | 60 | Ft per Min |
| Material Conveying | 6.57 | Inches |
| Depth | | |

SC-1305 Pellet Cooler Discharge Screw Conveyor

| | | |
|---|---|---|
| Conveyor Design Basis | 110% | of Planned Capacity |
| Design Material Flow | 59,092 | Lbs. per Hour |
| Material Bulk Density | 40.00 | Lbs. per Cu Ft |
| Screw Conveyor Diameter | 16.00 | Inches |
| Screw Conveyor Pipe Diameter | 4.00 | Inches |
| Pitch | 16.00 | Inches |
| Cu Ft per Rev | 1.75 | Cu Ft |
| Conveyor Loading | 50% | Loading |
| Calculated Conveyor Speed | 28.21 | RPM |

EL-1302 Pellet Storage Feed Leg

| | | |
|---|---|---|
| Conveyor Design Basis | 110% | of Planned Capacity |
| Design Material Flow | 59,092 | Lbs. per Hour |
| Material Bulk Density | 40 | Lbs. per Cu Ft |
| Material Flow Rate | 1,477 | Cu Ft per Hour |
| Bucket Elevator Model | Model 2414 | Intersystem |
| Bucket Elevator Cup Size | 9 × 5 | Cup Size |
| Bucket Elevator Rated Capacity | 3,855 | Cu Ft per Flour Nominal |
| Percent of Design Capacity | 261% | of Design Capacity |

DC-1401 Pellet Storage Distribution Drag Conveyor

| | | |
|---|---|---|
| Conveyor Design Basis | 110% | of Planned Capacity |
| Design Material Flow | 59,092 | Lbs. per Hour |
| Material Bulk Density | 40 | Lbs. per Cu Ft |
| Material Flow Rate | 1,477 | Cu Ft per Hour |
| Drag Conveyor Model | 9 × 12 | Series 12 Intersystem |
| Trough Width | 9 | Inches |
| Chain Speed | 60 | Ft per Min Chain Speed |
| Material Conveying | 6.57 | Inches product height in Conveyor |
| Depth | | |

Stover Shredding Air Assist

| | | |
|---|---|---|
| Screen Width | 48 | inches |
| Screen across Grinding | 63 | inches |
| Circumference | | |
| Total Screen Area | 2 | Screens per Unit |
| | 42 | Sq. Ft |
| Screen Open Area | 85% | Open Area |
| | 36 | Sq. Ft |
| Air at Shredder | 6,000 | CFM |
| | 1.17 | CFM per Sq. Inch of Screen |
| | | Open Area |

Grinder Assist and Pneumatic Transfer Air Flows

| | | |
|---|---|---|
| Planned Air Flow from Shredder | 6,000 | CFM |
| Plenum Chamber Size | 4.00 | Ft Diameter |
| | 1.00 | Ft Straight Sidewall |
| | 10.28 | Sq. Ft |
| Airflow | 583.5 | Ft per Min |
| Pneumatic Classifier Inlet | 56.00 | Inches Long |
| | 12.00 | Inches Wide |
| | 4.67 | Sq. Ft |
| Airflow at Pneumatic Classifier Inlet | 6,000 | CFM |
| | 1,286 | Ft per Min |
| Air Bleed into Pneumatic Separator | 2,500 | CFM |
| Planned Airflow Into Grinder | 8,500 | CFM |
| Grinder Inlet | 11.75 | Inches Wide |
| | 56.00 | Inches Long |
| | 4.57 | Sq. Ft |
| Air Flow at Grinder Inlet | 1,860 | Ft per Min |
| Planned Pneumatic Transfer Air | 10,293 | ACFM Each |
| Bypass Air at Grinder Bottom Platinum | 1,793 | CFM |

Dust Collection Air Flows

| | | |
|---|---|---|
| Ground Feed Leg Lower Pickup | 6.00 | Inch |
| | 785 | CFM |
| Ground Feed Leg Upper Pickup | 6.00 | Inch |
| | 785 | CFM |
| Pellet Feed Conveyor | 8.00 | Inch |
| | 1,396 | CFM |
| Total Flow to Dust Collector | 10.00 | Inch |
| | 2,967 | CFM |

Air Flow to Dust Collector

| | | |
|---|---|---|
| Planned Pneumatic Transfer Air | 10,293 | CFM |
| Dust Collection | 2,967 | CFM |
| Total Air to Dust Collector | 13,260 | CFM |

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed:

1. A method of processing biomass material, comprising:
shredding the biomass material with a shredder to reduce particle size;
conveying the shredded material to a grinder using a dual mechanical and pneumatic conveyor; and
grinding the shredded material with a grinder to further reduce particle size.

2. The method of claim 1 further comprising pulling air through the shredder and the grinders to pull the biomass material through the shredder and the grinder.

3. The method of claim 1 wherein the biomass material is agriculture residue.

4. The method of claim 1 wherein the conveyor moves substantially 50% by weight of the shredded material mechanically and 50% by weight of the shredded material pneumatically.

5. The method of claim 1 wherein the conveyor includes a belt for carrying a first portion shredded material and an air flow for carrying a second portion of the shredded material.

6. The method of claim 1 further comprising removing metal from the shredded material before grinding.

7. The method of claim 1 further comprising removing foreign material from the shredded material before grinding.

8. The method of claim 7 further comprising providing air from the shredder to conveyor, then to the separator for removing foreign material, and then to the grinder.

9. The method of claim 1 further comprising providing at least 6000 CFM air from the shredder to the conveyor.

10. The method of claim 9 wherein the 6000 CFM air is supplied from the conveyor to the grinder.

11. The method of claim 10 wherein additional air is provided to the grinder.

12. The method of claim 11 wherein the additional air is at least 2400 CFM.

13. The method of claim 1 wherein the ground material is pneumatically conveyed to a collection cyclone.

14. The method of claim 1 wherein supplemental air is supplied to a discharge of the grinder to pull biomass material through the grinder.

15. The method of claim 14 wherein the supplemental air is at least 7700 CFM.

16. A system for reducing biomass particulate size, comprising:
a shredder to shred biomass material to a first size range;
a grinder to grind the shredded biomass material to a second smaller size range; and
a combination mechanical and pneumatic conveyor to convey the shredded material from the shredder to the grinder.

17. The system of claim 16 further comprising a source for pulling air through the shredder, the conveyor, and the grinder so as to pull the biomass material through the shredder and the grinder.

18. The system of claim 16 further comprising a separator between the shredder and grinder to remove foreign matter from the shredded biomass material.

19. The system of claim 18 wherein air flow through the shredder is at least 6000 CFM.

20. The system of claim 18 further comprising a secondary air flow into the grinder.

21. The system of claim 20 further comprising a third air flow at a discharge of the grinder to pull biomass material through the grinder.

22. The system of claim 16 further comprising a magnet to remove ferrous material from the biomass material.

23. The system of claim 16 wherein the conveyor includes a belt for carrying a first portion of the shredded material and a housing with air flow there through for carrying a second portion of the shredded material.

24. A method of processing biomass material, comprising:
shredding the biomass material to reduce particle size;
grinding the shredded material to further reduce particle size; and
providing sufficient air flow through the shredder and grinder to assist movement of the biomass material through the shredder and the grinder.

25. The method of claim 24 wherein the air flow is pulled through the shredder and grinder.

26. The method of claim 24 further comprising using the air flow to convey the shredded material from the shredder to the grinder.

27. The method of claim 24 further comprising removing impurities from the shredded material before grinding.

28. The method of claim 24 wherein the air flow through the shredder is at least 6,000 CFM and the air flow through the grinder is at least 8,500 CFM.

29. The method of claim 24 wherein an additional air flow of at least 7,700 CFM is provided at a discharge end of the grinder.

30. A system for processing biomass material, comprising:
a shredder to shred the biomass material to a first size range;
a grinder to grind the shredded material to a second smaller size range; and
a source for pulling air through the shredder and the grinder so as to pull the biomass material through the shredder and grinder.

31. The system of claim 30 wherein the source is a fan downstream from the grinder.

32. The system of claim 30 further comprising a combination mechanical and pneumatic conveyor for conveying the shredded material from the shredder to the grinder.

33. The system of claim 30 wherein the source pulls at least 6,000 CFM through the shredder and the grinder.

34. The system of claim 33 further comprising a second source to provide additional air through the grinder.

35. The system of claim 33 further comprising a supplemental source for providing supplemental air adjacent a discharge end of the grinder.
